(19) United States
(12) Patent Application Publication
(10) Pub. No.: US 2008/0271708 A1
(43) Pub. Date: Nov. 6, 2008

(54) Fuel Metering Unit For a High-Pressure Fuel Pump, and High-Pressure Fuel Pump

(76) Inventor: Nestor Rodriguez-Amaya, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/909,755

(22) PCT Filed: Apr. 7, 2006
(86) PCT No.: PCT/EP2006/061419

§ 371 Date: Sep. 26, 2007

(30) Foreign Application Priority Data
Jun. 6, 2005 (DE) 10 2005 025 872.7

(51) Int. Cl. F02M 59/36

(52) U.S. Cl. 123/446; 123/495; 417/279

(57) ABSTRACT

The invention relates to a fuel metering unit, in which the displaceable parts of an electromagnet are guided through two bushings in an axial direction, the bushings being located at a distance from one another. The bushings guide the armature bolt, which can be produced from a wear-resistant material, such as for example tempered steel.

### PRIOR ART

The invention is based on a fuel metering unit for intake-side regulating the supply quantity of the high-pressure fuel pump of an internal combustion engines in which the fuel metering unit has a regulating valve, actuated by an electromagnet, with a valve piston, and the electromagnet includes an armature and an armature bolt and a bearing bush, and having a bearing bush.

A fuel metering unit of this kind is known for instance from German Patent Disclosure DE 102 42 219 A1.

In that fuel metering unit, the armature of the electromagnet is surrounded by a bearing bush and guided axially displaceably.

The object of the invention is to furnish a fuel metering unit with better operating performance and a longer service life.

This object is attained according to the invention in a fuel metering unit for intake-side regulating the supply quantity of the high-pressure fuel pump of an internal combustion engine, in which the body has a regulating valve, actuated by an electromagnet, with a valve piston, and the electromagnet includes an armature and an armature bolt and a bearing bush, and in which the armature, armature bolt and valve piston are joined together, and having a bearing bush, is attained in that a first bearing bush is disposed between the armature bolt and the valve piston, and that the first bearing bush guides the armature bolt axially displaceably.

### ADVANTAGES OF THE INVENTION

Because of the guidance according to the invention of the moving parts of the fuel metering unit on the armature bolt, the friction between the bearing bush and the moving part is reduced markedly, since the diameter of the armature bolt is much smaller than that of the armature, so that the contact area between the bearing bush and the part to be supported is reduced drastically in the fuel metering unit of the invention.

In the fuel metering unit known from the prior art, not insignificant wear occurs in the operation of the fuel metering unit of the invention, since the armature is soft-annealed in order to optimize the magnetic properties.

It is furthermore possible to produce the armature bolt from a more wear-resistant material than tempered steel, for instance. By means of suitable surface machining, such as grinding or superfinishing, the surface roughness of the armature bolt can furthermore be kept quite slight, which in turn has a positive effect on the frictional forces between the bearing bush and the armature bolt and drastically reduces wear.

As a result, it is thus possible to furnish a fuel metering unit whose response performance is improved, and in which the hysteresis between an opening motion and a closing motion is reduced to one-fourth of that in conventional fuel metering units. Moreover, the production costs are reduced, since the first bearing bush according to the invention has a much smaller diameter and can consequently be produced more economically.

In a further advantageous feature of the invention, a second bearing bush may be disposed between the armature bolt and the valve piston, and the second bearing bush also guides the armature bolt axially displaceably. By means of these two bearing bushes, which are advantageously disposed with an axial spacing from one another, the guidance of the armature bolt is further improved. Because of the two spaced-apart bearing bushes, the armature bolt can no longer tilt or be deflected laterally, so that the armature is guided with very good alignment with the magnet coil. As a result, the operating performance and the service life of the fuel metering unit of the invention are further improved.

Alternatively, it is also possible to dispose the second bearing bush on the end of the armature bolt remote from the valve piston, and to guide the armature bolt axially displaceably in the second bearing bush as well. As a result, the aforementioned advantages are also attained, and the bearing bushes are very evenly loaded.

Which of the aforementioned variants will be given preference in an individual case depends on the other peripheral conditions of the individual case and must be decided in the individual case by the person skilled in the art tasked with the construction.

Advantageously, the armature bolt protrudes past the magnet, if the second bearing bush is disposed on the end of the mature bolt remote from the valve piston. Is this case, the second bearing bush can advantageously be secured in a magnet pot of the electromagnet.

The bearing bushes disposed between the magnet aid the valve piston can advantageously be secured in a valve housing of the fuel metering unit.

In practical tests, it has proved advantageous if the bearing bushes are produced from bronze. Alternatively, it is also possible to produce the bearing bushes of plastic, in particular fuel-resistant and heat-resistant plastic.

If necessary, in a further advantageous feature of the invention, the valve piston may be guided in the valve housing.

Further advantages and advantageous features of the invention can be learned from the ensuing drawings, their description, and the claims. All the characteristics disclosed in the drawings, their description, and the claims may be essential to the invention both individually and in arbitrary combination with one another.

### DRAWINGS

Shown are:

FIG. 1, a first exemplary embodiment of a fuel metering unit according to the invention; and

FIG. 2, a second exemplary embodiment of a fuel metering unit according to the invention.

### DESCRIPTION OF THE EXEMPLARY EMBODIMENTS

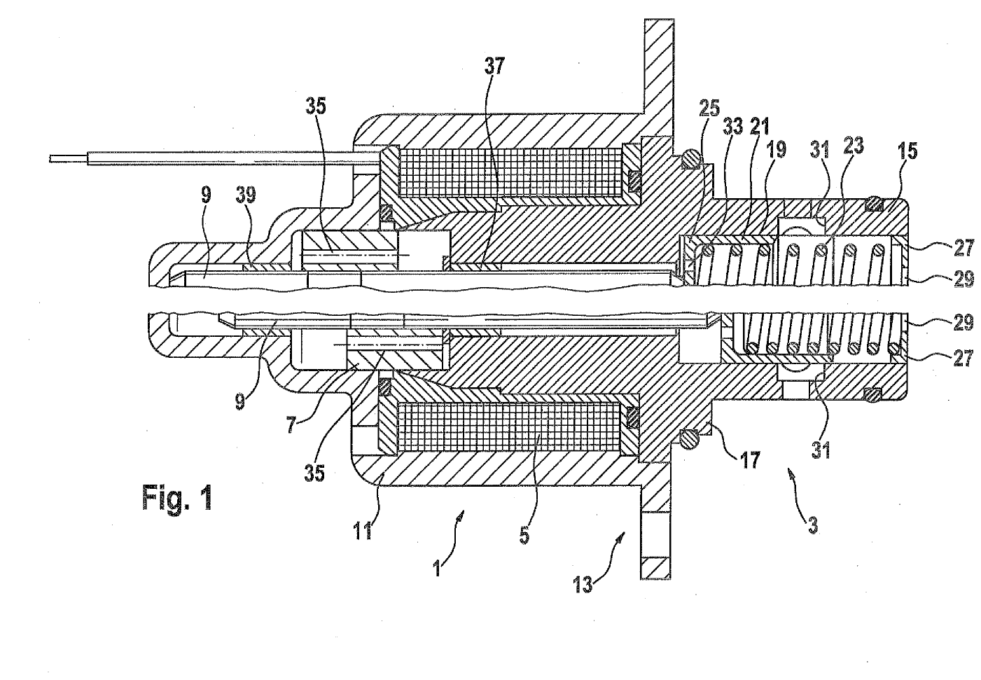

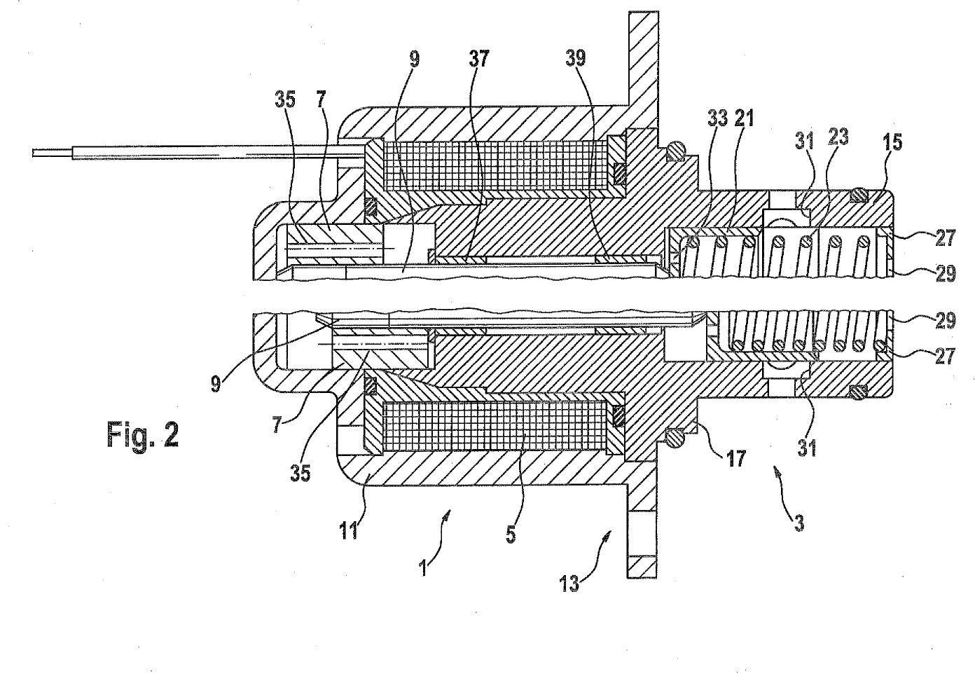

The fuel metering unit of FIGS. 1 and 2 is based on an electromagnet 1 with an integrated regulating valve 3. The most important components of the electromagnet 1 are a magnet coil 5, an armature 7 with an armature bolt 9, and a magnet pot 11, which partly surrounds the magnet coil 5 and the armature 7.

The complete fuel metering unit is disposed in a high-pressure fuel pump, not shown. The magnet pot 11 serves here as a sealing element, a magnetic short circuit, and a securing element in the high-pressure pump simultaneously. The securing function is performed essentially by the flange 13.

The regulating valve 3 has a valve housing 15, which changes over to a widened portion 17 that at the same forms the face-end closure of the magnet pot 11.

In the valve housing 15, there is an axial bore 19, which is disposed coaxially to the armature bolt 9 of the electromagnet 1. The axial bore 19 receives a displaceable, sleevelike valve piston 21, in the interior of which a compression spring 23 is disposed. The compression spring 23 is braced on one end on a bottom 25 of the valve piston 21. On the other end, the compression spring 23 is braced on a spring plate 27 located in the axial bore 19. On the end of the valve piston 21 remote from the spring plate 27, the valve piston is in contact with one end of the armature bolt 9. The compression spring 23 assures that any adjusting motion of the armature bolt 9 will be transmitted directly to the valve piston 21.

An opening 29 in the spring plate 27 connects the interior (not identified by reference numeral) of the valve piston 21 to a prefeed pump, not shown, of the fuel injection system.

A plurality of radially oriented control openings 31 are disposed in the valve housing 15. The control openings 31 are in hydraulic operative communication with the low-pressure region of the high-pressure fuel pump, not shown.

The flow direction from the opening 29 through the valve piston 21 and the control openings 31 can also be reversed. In that case, the control openings 31 would then communicate with the pressure side of the prefeed pump, while the opening 29 would communicate hydraulically with the low-pressure region of the high-pressure pump.

The upper half of FIG. 1 shows the regulating valve 11 in the open position, in which the control opening 31 is completely opened by the valve piston 21. In the lower half of FIG. 1, the regulating valve 3 shown in its closing position. Here, the magnetic force of the electromagnet 1 that has been supplied with current acts on the valve piston 21 via the armature 7 and the armature bolt 9 and moves the valve piston into the aforementioned closing position counter to the compression spring 23.

Conversely, the compression spring 23 is capable of displacing the valve piston 21 into the opening position, as soon as the current supply to the electromagnet 1 and hence its magnetic force acting on the armature 7 and the armature bolt 9 have been reduced accordingly.

In the opening position of the regulating valve 3, the fuel supplied to the regulating valve at the opening 29 flows to the intake side of the high-pressure fuel pump (not shown).

A compensation bore 33 is provided in the bottom 25 of the valve piston 21. Compensation bores 35 are also provided in the armature 7.

In the first exemplary embodiment shown in FIG. 1, the armature bolt 9 protrudes past the armature 7 into the magnet pot 11.

In the region between the armature 7 and the valve piston 21, a first bearing bush 37 is press-fitted into the valve housing 15. The bearing bush 37 serves to guide the armature bolt 9 and with it the armature 7 in the axial direction. Since the armature bolt 9 can be produced from a wear-resistant material, such as tempered steel, the bearing of the moving parts of the electromagnet 1, with the aid of the first bearing bush 37, is very long-lived and virtually wear-free. Because of the intrinsically small diameter of the armature bolt 9 in comparison to the outer diameter of the armature 7, the friction between the first bearing bush 37 and the armature bolt 9 is also very slight.

To achieve still further improvement in the guidance of the armature bolt 9 and with it of the armature 7, a second bearing bush 39 is press-fitted into the magnet pot 11 on the end of the armature bolt 9 remote from the valve piston 21. This prevents the armature bolt 9 from tilting. Because the armature bolt is guided on both sides, it is also assured that the armature 7 cannot be deflected in the radial direction, for instance if the magnetic forces exerted on the armature 7 by the magnet coil 6 have a radial component. Because of the precise, low-wear guidance of the armature bolt 9 in the bearing bushes 37 and 39, it is also assured that the armature 7 will not come into contact with the magnet pot 11, and thus neither friction nor wear can occur there, either.

In FIG. 2, a second exemplary embodiment of a fuel metering unit of the invention is shown, in which the structural length is shortened somewhat compared to the first exemplary embodiment, and at the same time precise, low-wear guidance of the armature bolt 9 and with it the armature 7 is achieved. In this second exemplary embodiment, both the first bearing bush 37 and the second bearing bush 39 are disposed in the region between the armature 7 and the valve piston 21. Both bearing bushes 37 and 39 are press-fitted into the magnet pot 11 and are spaced apart from one another in the axial direction of the armature bolt 9. As a result, tilting of the armature bolt 9 and thus also scraping or contact between the armature 7 and the magnet pot 11 are effectively prevented. As a consequence, the second exemplary embodiment has the same advantages as the first exemplary embodiment.

1-13. (canceled)

14. In a fuel metering unit for intake-side regulating the supply quantity of the high-pressure fuel pump of an internal combustion engine, in which the fuel metering unit has a regulating valve, actuated by an electromagnet with a valve piston the electromagnet including an armature, an armature bolt and a first bearing bush disposed between the armature and the valve piston, the first bearing bush guiding the armature bolt axially displaceably.

15. The fuel metering unit as defined by claim 14, further comprising a second bearing bush disposed between the armature and the valve piston and guiding the armature bolt axially displaceably.

16. The fuel metering unit as defined by claim 14, further comprising a second bearing bush disposed on the end of the armature bolt remote from the valve piston and guides the armature bolt axially displaceably.

17. The fuel metering unit as defined by claim 16, wherein the armature bolt protrudes past the armature.

18. The fuel metering unit as defined by claim 14, wherein the second bearing bush is disposed on the end of the armature bolt remote from the valve piston and is secured in a magnet pot.

19. The fuel metering unit as defined by claim 15, wherein the second bearing bush is disposed on the end of the armature bolt remote from the valve piston and is secured in a magnet pot.

20. The fuel metering unit as defined by claim 15, wherein the bearing bushes disposed between the armature and the valve piston are secured in a valve housing.

21. The fuel metering unit as defined by claim 18, wherein the bearing bushes disposed between the armature and the valve piston are secured in a valve housing.

22. The fuel metering unit as defined by claim 14, wherein the electromagnet is embodied as a plunging armature magnet.

23. The fuel metering unit as defined by claim 15, wherein the bearing bushes are produced from bronze.

24. The fuel metering unit as defined by claim 15, wherein the bearing bushes comprise fuel-resistant and/or temperature-resistant plastic.

25. The fuel metering unit as defined by claim 14, wherein the valve piston is guided in the valve housing.

26. The fuel metering unit as defined by claim 20, wherein the valve piston is guided in the valve housing.

27. The fuel metering unit as defined by claim 21, wherein the valve piston is guided in the valve housing.

28. The fuel metering unit as defined by claim 20, wherein the valve piston is embodied in sleevelike form and in its interior receives a compression spring; and wherein the compression spring is braced on one end, at least indirectly, on the valve housing.

29. The fuel metering unit as defined by claim 28, further comprising a spring plate in the valve housing, the compression spring being braced on one end against the spring plate.

30. A high-pressure fuel pump for a fuel injection system, comprising at least one pump element, and a fuel metering unit as defined in claim 14, for regulating the supply quantity.

31. A high-pressure fuel pump for a fuel injection system, comprising at least one pump element, and a fuel metering unit as defined in claim 15, for regulating the supply quantity.

32. A high-pressure fuel pump for a fuel injection system, comprising at least one pump element, and a fuel metering unit as defined in claim 18, for regulating the supply quantity.

33. A high-pressure fuel pump for a fuel injection system, comprising at least one pump element, and a fuel metering unit as defined in claim 20, for regulating the supply quantity.
